(19) United States
(12) Patent Application Publication
(10) Pub. No.: US 2026/0036806 A1
(43) Pub. Date: Feb. 5, 2026

(54) OPTICAL SCANNING DEVICE

(71) Applicant: CANON KABUSHIKI KAISHA, Tokyo (JP)

(72) Inventors: MITSUHIRO OBARA, Shizuoka (JP); TAKU MUROTANI, Shizuoka (JP); HIROKI KATAYAMA, Shizuoka (JP)

(21) Appl. No.: 19/282,322

(22) Filed: Jul. 28, 2025

(30) Foreign Application Priority Data
Jul. 30, 2024 (JP) 2024-123751

(51) Int. Cl. G02B 26/12; G03G 15/043

(52) U.S. Cl. CPC G02B 26/125; G03G 15/0435

(57) ABSTRACT

An optical scanning device includes a light source, a rotary polygon mirror configured to deflect a light beam from the light source, a scanning lens through which the light beam passes, a reflection mirror configured to reflect and guide the light beam to a surface to be scanned and having an elongated shape in a longitudinal direction, and a casing configured to support the light source, the rotary polygon mirror, the scanning lens, and the reflection mirror, wherein the casing includes a pair of holding units configured to hold both ends of at least one of the scanning lens or the reflection mirror in the longitudinal direction, the holding unit closer to the light source has a side wall extending in the axial direction from a bottom of the casing, and, on the side wall, a diaphragm configured to restrict an incident beam to the rotary polygon mirror is arranged.

### BACKGROUND

### Field of the Technology

The present disclosure relates to an optical scanning device installed in an electrophotographic image forming apparatus such as a laser beam printer (LBP) and a digital copier.

### Description of the Related Art

An optical scanning device (a laser scanner) installed in an electrophotographic image forming apparatus, such as a laser beam printer, includes a light source, a deflector, an imaging lens (a scanning lens), and a reflection mirror. The light source emits a laser beam corresponding to an image signal, and the deflector deflects the laser beam. The imaging lens focuses the deflected laser beam to form an image on a photosensitive drum. The deflector, the imaging lens, and the reflection mirrors are installed in a housing (a casing).

Image forming apparatuses that form full color images include an inline-type image forming apparatus in which a plurality of photosensitive drums for respective colors is linearly arranged. In a case where such an image forming apparatus is designed to be smaller, a distance between the plurality of photosensitive drums may be shortened. With the shortening of the distance between the plurality of photosensitive drums, various optical components inside an optical scanning device are disposed closer to each other. For example, as discussed in Japanese Patent Application Laid-Open No. 2021-26038, an optical component, such as an imaging lens and a reflection mirror, may be disposed near a deflector.

In a case where the imaging lens and the reflection mirror are disposed near the deflector, a holding unit arranged in a housing to hold the imaging lens and the reflection mirror may be disposed on an optical path that is provided from a light source to the deflector. In such a case, an aperture through which a laser beam passes needs to be arranged in the holding unit in the housing.

From a cost standpoint, housings are often manufactured by injection molding of resin. In such a case, the housing is generally formed using a mold structure called a core-cavity. In a case where the core-cavity is used, a direction in which a mold is opened and closed when a molded part is separated from the mold is limited to one direction. Consequently, arrangement of an aperture in the holding unit widens the aperture in the open-close direction of the mold, causing an increase in aperture size. In a case where the aperture size is increased, dust is likely to enter the housing from the outside. As a result, adhesion of the dust to an optical component degrades image quality.

### SUMMARY

The present disclosure is directed to an optical scanning device enabling a hole through which a light beam passes to be smaller in a holding unit and having good dust-proof performance.

According to an aspect of the present disclosure, an optical scanning device includes a light source, a rotary polygon mirror configured to deflect a light beam to be emitted from the light source, a scanning lens through which the light beam deflected by the rotary polygon mirror passes, a reflection mirror configured to reflect the light beam deflected by the rotary polygon mirror to guide the light beam to a surface to be scanned, the reflection mirror having an elongated shape in a longitudinal direction that is orthogonal to an axial direction of a rotational axis of the rotary polygon mirror, and a casing configured to support the light source, the rotary polygon mirror, the scanning lens, and the reflection mirror, wherein the casing includes a pair of holding units configured to hold both ends of at least one of the scanning lens or the reflection mirror in the longitudinal direction, wherein, among the pair of holding units, the holding unit closer to the light source in the longitudinal direction has a side wall extending in the axial direction from a bottom of the casing, and wherein, on the side wall, a diaphragm configured to restrict an incident beam to the rotary polygon mirror from the light source is arranged.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of an image forming apparatus according to a present exemplary embodiment.

FIG. 2 is a plan view of an optical scanning device according to the present exemplary embodiment.

FIGS. 3A and 3B are sectional views of an incident optical system in the optical scanning device according to the present exemplary embodiment.

FIG. 4 is a sectional view of an optical scanning system in the optical scanning device according to the present exemplary embodiment.

FIG. 5 is a perspective view of a state in which a reflection mirror is held according to the present exemplary embodiment.

FIG. 6 is a perspective view of a holding unit according to the present exemplary embodiment.

FIGS. 7A and 7B are schematic diagrams of a mold structure for forming a shape of an aperture diaphragm according to the present exemplary embodiment.

FIG. 8 is a perspective view of a holding unit in a comparative example.

FIG. 9 is a schematic diagram illustrating a mold structure in a case where an aperture shape is formed in the comparative example.

FIG. 10 is a schematic diagram illustrating an airflow in the optical scanning device according to the present exemplary embodiment.

FIG. 11 is a schematic diagram illustrating an airflow in the incident optical system according to the present exemplary embodiment.

FIG. 12 is a schematic diagram illustrating influence on performance due to a difference in position of a main-scanning aperture diaphragm.

FIG. 13 is a perspective view of an optical scanning device in a modification example of the present exemplary embodiment.

### DESCRIPTION OF THE EMBODIMENTS

### Image Forming Apparatus

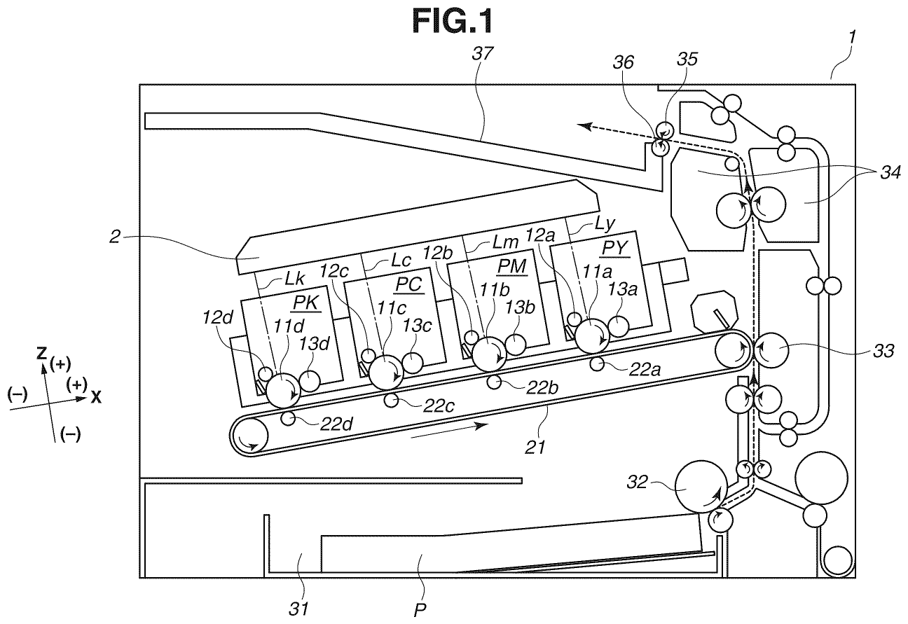

FIG. 1 is a schematic sectional view of an image forming apparatus 1 of the present exemplary embodiment. The image forming apparatus 1 is a printer using an electrophotographic recording technique and is a color printer that forms a full color image by superimposing images in four colors of yellow, cyan, magenta, and black.

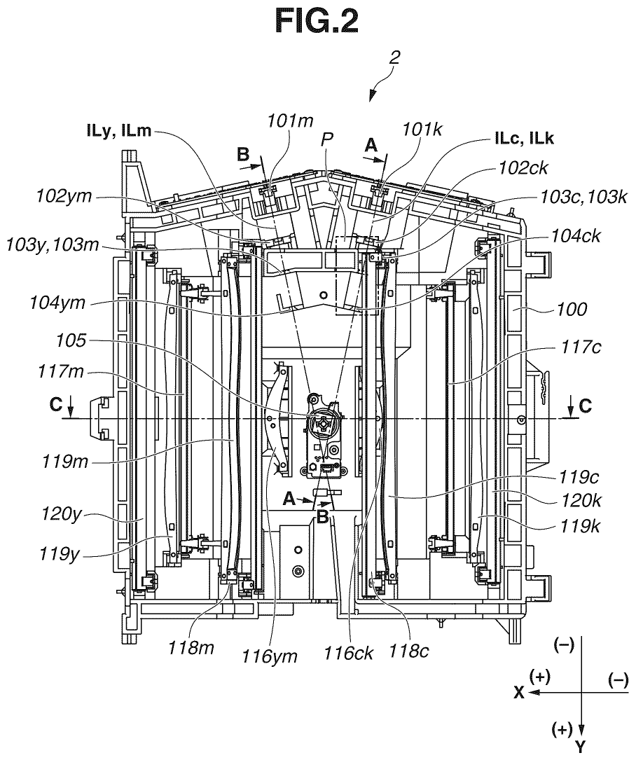

An image forming process is described. Process cartridges PY, PM, PC, and PK for respective colors respectively include photosensitive drums 11a, 11b, 11c, and 11d, charging rollers 12a, 12b, 12c, and 12d of charging devices, and developing rollers 13a, 13b, 13c, and 13d of developing devices. The photosensitive drums (surfaces to be scanned) 11a, 11b, 11c, and 11d charged beforehand by the charging rollers 12a, 12b, 12c, and 12d are respectively scanned with laser beams Ly, Lm, Lc, and Lk emitted from an optical scanning device 2 that is an exposure device. Accordingly, electrostatic latent images corresponding to image information are formed on surfaces of the respective photosensitive drums 11a, 11b, 11c, and 11d. The electrostatic latent images are developed as toner images by the developing rollers 13a, 13b, 13c, and 13d, and the toner images are transferred to an intermediate transfer belt 21 by primary transfer rollers 22a, 22b, 22c, and 22d. Meanwhile, a recording medium P, placed inside a sheet cassette 31 disposed below the intermediate transfer belt 21, is picked up by a pickup roller 32. The recording medium P is picked up at a timing with the above-mentioned image forming process. Then, the toner images in four colors on the intermediate transfer belt 21 are transferred to the recording medium P by a secondary transfer roller 33. The recording medium P on which the toner images have been transferred is fixed by a fixing device 34, and then the recording medium P is discharged to a sheet discharge tray 37 outside the image forming apparatus 1 by discharge rollers 35 and 36. A direction indicated by an arrow X (also called an X direction) illustrated in FIG. 1 is a direction in which the photosensitive drums 11a, 11b, 11c, and 11d are arranged, and a direction indicated by an arrow Z (also called a Z direction) is a direction orthogonal to the X direction. A direction indicated by an arrow Y (also called a Y direction) illustrated in FIG. 2 is a direction orthogonal to the X direction and the Z direction.

### Optical Scanning Device

An overall configuration of the optical scanning device 2 according to the present exemplary embodiment is described with reference to FIGS. 2 through 4.

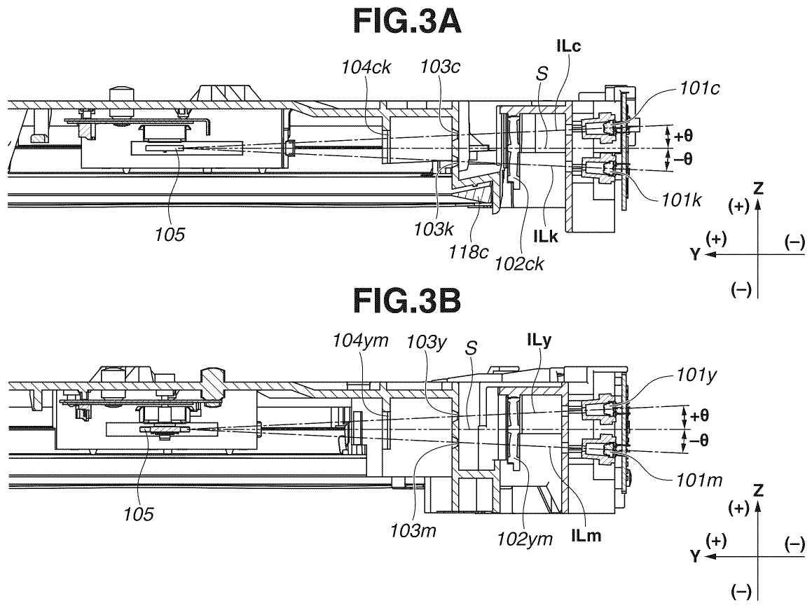

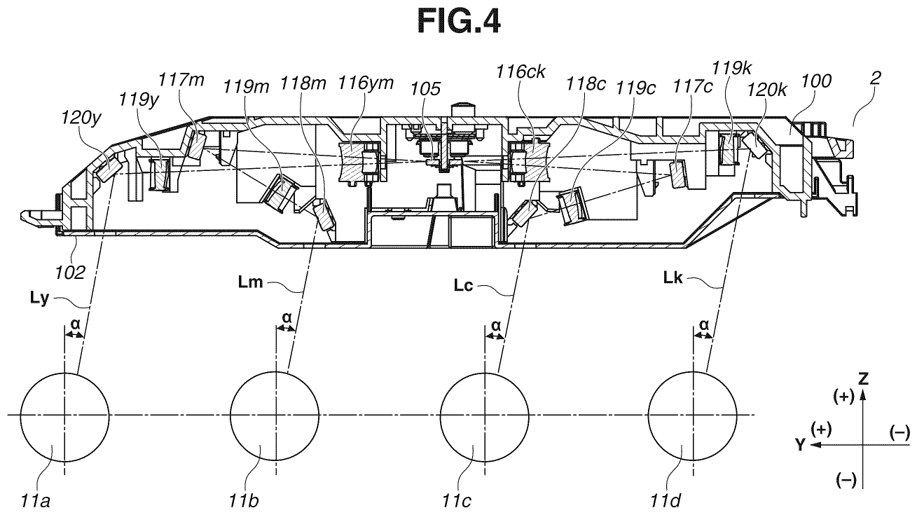

FIG. 2 is a plan view of the optical scanning device 2 as seen in a +Z direction from the process cartridges PY, PM, PC, and PK illustrated in FIG. 1. FIG. 3A is a sectional view of the optical scanning device 2 as seen in an A direction illustrated in FIG. 2, and FIG. 3B is a sectional view of the optical scanning device 2 as seen in a B direction illustrated in FIG. 2. Each of these drawings illustrates a state in which a cover member, as a component with which an opening of the optical scanning device 2 is covered, is removed for the sake of convenience of description. FIG. 4 is a sectional view of the optical scanning device 2 as seen in a C direction illustrated in FIG. 2. In FIG. 4, the photosensitive drums 11a, 11b, 11c, and 11d, which are components of the image forming apparatus 1, are also illustrated for the sake of convenience of description.

An optical beam path to a rotary polygon mirror 105 is called an incident optical system, and the optical beam path is described with reference to FIGS. 2, 3A and 3B. Incident laser beams ILy, ILm, ILc, and ILk emitted from light sources 101y, 101m, 101c, and 101k are transmitted through anamorphic lenses 102ym and 102ck. The incident laser beams ILy, ILm, ILc, and ILk have beam widths that are restricted by sub-scanning aperture diaphragms (also referred to as sub-scanning diaphragms) 103y, 103m, 103c, and 103k (indicated by hidden lines in FIG. 2) and main-scanning aperture diaphragms (also referred to as main-scanning diaphragms) 104ym and 104ck. Each of the incident laser beams ILy, ILm, ILc, and ILk is formed as a line image having a certain width on a deflection reflection surface of the rotary polygon mirror 105. Each of the sub-scanning aperture diaphragms 103y, 103m, 103c, and 103k has a shape that enables a beam width to be restricted also in a main-scanning direction that is a rotation direction of the rotary polygon mirror 105. However, the beam width in the main-scanning direction on the rotary polygon mirror 105 is ultimately restricted by the main-scanning aperture diaphragms 104ym and 104ck. The rotation of the rotary polygon mirror 105 deflects an incident laser beam.

The optical scanning device 2 includes the anamorphic lens having two functions of a collimator lens that causes a laser beam to be a parallel beam and a cylinder lens that causes laser beams to converge in one direction. However, the optical scanning device 2 may include a collimator lens and a cylinder lens that are separately arranged.

As illustrated in FIGS. 3A and 3B, the light sources and the anamorphic lenses are arranged such that the incident laser beams ILy and ILm and the incident laser beams ILc and ILk have an angle of ±θ° relative to a scanning plane S of the rotary polygon mirror 105. Among incident optical systems, such arrangement is called a sub-scanning oblique incident optical system, and one rotary polygon mirror enables incident laser beams for four colors to be deflected and scanned at the same time.

An optical beam path from the rotary polygon mirror 105 to the photosensitive drums 11a, 11b, 11c, and 11d is called an optical scanning system, and the optical beam path is described with reference to FIG. 4. The incident laser beams ILy, ILm, ILc, and ILk are deflected and scanned by the rotary polygon mirror 105, and are scanned as laser beams Ly, Lm, Lc, and Lk. The incident laser beams ILy, ILm, ILc, and ILK correspond to the laser beams Ly, Lm, Lc, and Lk, respectively. The laser beams Ly and Lc are reflected in a-Z direction by the rotary polygon mirror 105, whereas the laser beam Lm and Lk are reflected in a +Z direction by the rotary polygon mirror 105. Subsequently, the laser beams Ly and Lm enter a first imaging lens (a first scanning lens) 116ym, whereas the laser beams Lc and Lk enter a first imaging lens (a first scanning lens) 116ck.

The subsequent part of the optical beam path is described using the laser beams Lk and Lc since the laser beams Ly and Lk and the laser beams Lm and Lc are similar.

The laser beam Lk forms an image on the photosensitive drum 11d via a second imaging lens (a second scanning lens) 119k and a first reflection mirror 120k, whereas the laser beam Lc forms an image on the photosensitive drum 11c via a first reflection mirror 117c, a second imaging lens (a second scanning lens) 119c, and a second reflection mirror 118c. Spot sizes of the laser beams Lc and Lk, which form images on the respective photosensitive drums 11c and 11d, are determined based on the various lenses that have been described, the main-scanning aperture diaphragm 104ck, and the sub-scanning aperture diaphragms 103c and 103k.

As illustrated in FIG. 4, the laser beams Ly, Lm, Lc, and Lk diagonally enter at an angle a relative to the respective photosensitive drums 11a, 11b, 11c, and 11d because of restrictions on arrangement of a device body. With reduction in size of the apparatus, space between the photosensitive drums 11a, 11b, 11c, and 11d in an X direction is small. Thus, as a distance in the X direction, the rotary polygon mirror 105 is close to the photosensitive drum 11c. As a result, as a distance in the X direction, the second reflection mirror 118c is close to the rotary polygon mirror 105. As illustrated in an area P illustrated in FIG. 2, an end portion of the second reflection mirror 118c overlaps the incident laser beam ILc on an XY plane (the scanning plane S). Each of the imaging lenses is fixed to a housing (the casing) 100 with an ultraviolet (UV) adhesive, and each of the reflection mirrors is fixed to the housing 100 by using an urging member.

### Holding Unit

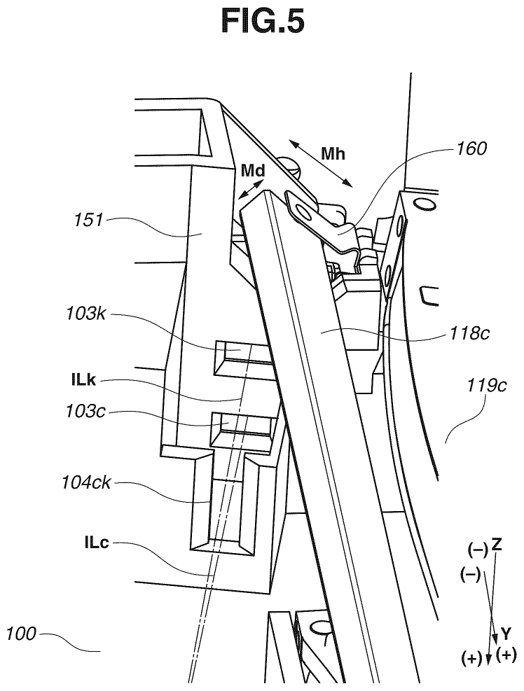

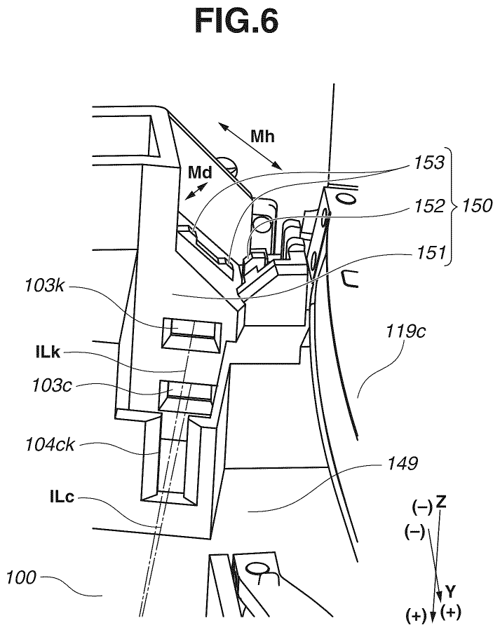

A description is given of holding of the second reflection mirror 118c in the housing 100. FIG. 5 is a perspective view of the area P illustrated in FIG. 2. As illustrated in FIG. 5, the second reflection mirror 118c is held by a holding unit 150 (not illustrated in FIG. 5, but described with reference to FIG. 6) including a side wall 151 arranged in the housing 100. The second reflection mirror 118c is supported by being pressed by a mirror pressing spring 160. In a longitudinal direction of the second reflection mirror 118c in FIG. 5, a holding configuration in one end of the reflection mirror near the light source is illustrated. However, the other end is also held by the similar configuration. As illustrated in FIG. 5, a thickness direction and a height direction of the second reflection mirror 118c are respectively defined as an Md direction and an Mh direction.

The holding unit 150 is described in detail with reference to FIG. 6. FIG. 6 is a diagram similar to FIG. 5, but the second reflection mirror 118c and the mirror pressing spring 160 are excluded from FIG. 6. The holding unit 150 includes the side wall 151 extending in an axial direction (−Z direction) of a rotational axis of the rotary polygon mirror 105 from a bottom 149 of the housing 100. The holding unit 150 also includes a contact surface 152 that contacts the second reflection mirror 118c in the Mh direction, and a contact surface 153 that contacts the second reflection mirror 118c in the Md direction. On the side wall 151, sub-scanning aperture diaphragms 103c and 103k are arranged. Each of the sub-scanning aperture diaphragms 103c and 103k has a restriction hole (a diaphragm) that restricts a shape of an incident laser beam to a desired shape in a sub-scanning direction. The arrangement of the sub-scanning aperture diaphragms 103c and 103k on the side wall 151 can reduce a size of an aperture through which an incident laser beam passes in the holding unit 150.

### Mold Structure for Forming Aperture Diaphragm

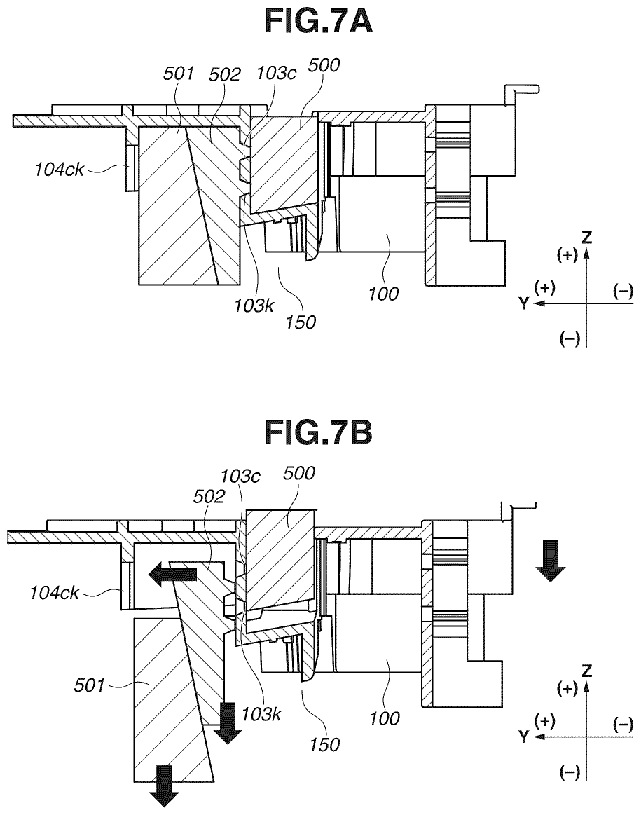

To arrange the sub-scanning aperture diaphragms 103c and 103k on the side wall 151, not only a core-cavity that is a general mold structure, but also a mold structure called an inclined core is necessary. An operation of a mold when the sub-scanning aperture diaphragms 103c and 103k are arranged on the holding unit 150 is described with reference to FIGS. 7A and 7B. FIG. 7A illustrates a position of a mold when the sub-scanning aperture diaphragms 103c and 103k are formed, and FIG. 7B illustrates a position of a mold when a molded part is separated. In the description, only necessary portions of the mold are illustrated for the sake of convenience of description. A shape in a +Z direction of the housing 100 is formed by a cavity 500 where the mold is fixed, and a shape in a −Z direction of the housing 100 is formed by a core 501 where the mold is movable. The use of a mold structure including only the cavity 500 and the core 501 causes each of the sub-scanning aperture diaphragms 103c and 103k to be formed in an undercut shape that cannot be separated in an open-close direction of the mold. Accordingly, the sub-scanning aperture diaphragms 103c and 103k are formed using an inclined core 502.

When a molded part is separated as illustrated in FIG. 7B, a position of the cavity 500 is fixed, and the housing 100 as a molded part and the core 501 move in a −Z direction relative to the cavity 500.

With the movement of the core 501, the inclined core 502 moves in a −Z direction in FIG. 7B while moving in a +Y direction. Thus, a molded part can be separated without undercut.

### Mold Structure for Forming Aperture in Comparative Example

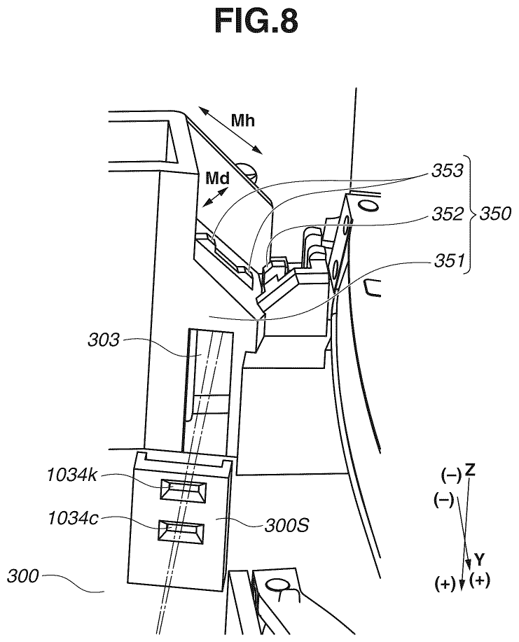

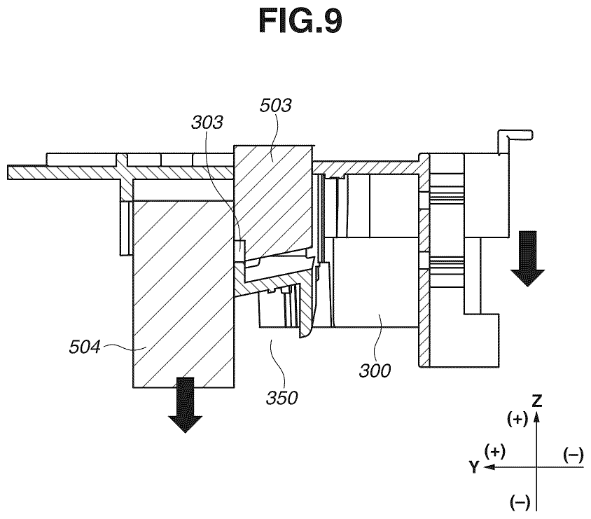

A shape around a holding unit in a case in which the holding unit is formed by using only a core-cavity, which is the general mold structure without using an inclined core, is described with reference to FIGS. 8 and 9. FIG. 8 is a perspective view of a housing 300. In FIG. 8, a reflection mirror and a pressing spring are excluded for the sake of convenience of description. FIG. 9 is a sectional view illustrating a mold when the housing 300 is separated from the mold.

The housing 100 according to the present exemplary embodiment has a configuration in which the sub-scanning aperture diaphragms 103c and 103k are arranged in the holding unit 150. On the other hand, the housing 300 in the comparative example has a configuration in which a sub-scanning aperture diaphragm is not arranged in a holding unit 350. A large aperture portion 303 through which an incident laser beam passes is arranged in the holding unit 350. Sub-scanning aperture diaphragms 1034c and 1034k are arranged in a portion 300S that extends from a bottom of the housing 300 and is different from the holding unit 350. Each of the sub-scanning aperture diaphragms 1034c and 1034k also has a function of a main-scanning aperture diaphragm.

The holding unit 350 has a shape to hold a second reflection mirror disposed in a similar manner to the optical scanning device 2. As illustrated in FIG. 8, the holding unit 350 includes a side wall 351, a contact surface 352 that contacts the second reflection mirror in an Mh direction, and a contact surface 353 that contacts the second reflection mirror in an Md direction, and the aperture portion 303 is arranged on the side wall 351.

As illustrated in FIG. 9, the shape around the holding unit 350 arranged in the housing 300 is formed by a cavity 503 and a core 504. The aperture portion 303 is formed by the cavity 503. Since the aperture portion 303 needs to be in a shape that can be separated by the cavity 503 and the core 504, a shape of the aperture portion 303 cannot be arranged in a +Z direction that is an open-close direction of a mold. Consequently, as illustrated in FIG. 8, the aperture portion 303 is a hole extending in a Z direction on the side wall 351 of the holding unit 350.

In the present exemplary embodiment as described, the sub-scanning aperture diaphragms 103c and 103k are arranged on a side wall of the holding unit 150, so that an aperture size can be reduced. In the configuration of the present exemplary embodiment, since a plurality of light sources is arranged in a Z direction, an effect of reducing the aperture size of the sub-scanning aperture diaphragms 103c and 103k is higher than that of the aperture portion 303 of the comparative example.

### Description of Dust-Proof Effect

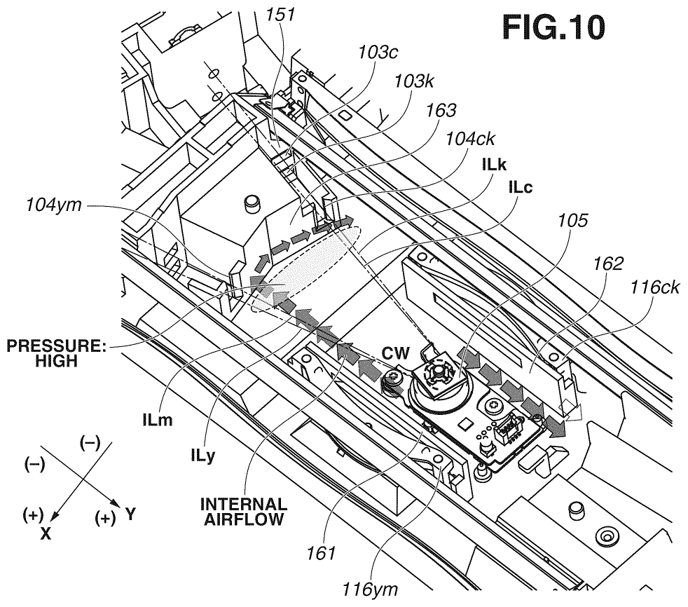

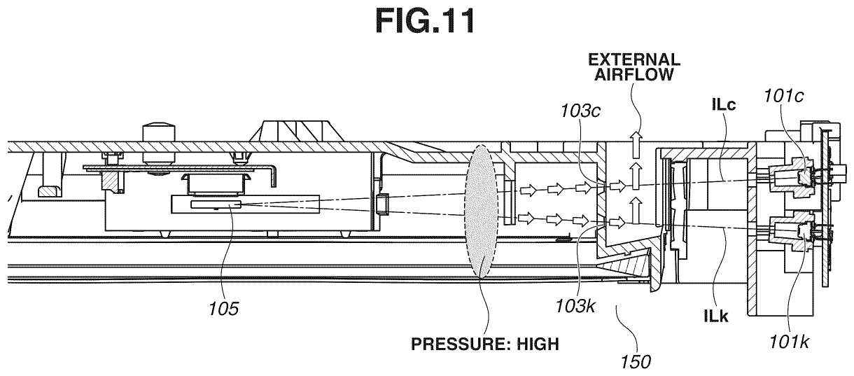

Reduction in aperture size enhances dust-proof performance of the optical scanning device 2. A reason for such enhancement is described with reference to FIGS. 10 and 11.

FIG. 10 is a perspective view of the optical scanning device 2. The rotary polygon mirror 105 rotates in a direction indicated by an arrow CW, and an internal airflow is generated with the rotation of the rotary polygon mirror 105. On the periphery of the rotary polygon mirror 105, because light-shielding walls 161 and 162 of the housing 100 and the first imaging lenses 116ym and 116ck are arranged in a Y direction, an airflow direction is restricted, and the internal airflow flows in the ±Y directions as illustrated in FIG. 10. Herein, the internal airflow flowing in a −Y direction in which the light source is arranged comes into contact with a wall 163 on which the main-scanning aperture diaphragms 104ym and 104ck are arranged. When fluid comes into contact with an object such as a wall, a flow speed is decreased and an air pressure increases. Accordingly, the air pressure on the periphery of the wall 163 increases. Because the wall 163 is arranged near the incident laser beams ILc and ILK, an area having a higher pressure than the periphery is generated on the incident laser beams ILc and ILk.

In FIG. 11, similarly to FIG. 3A, an airflow in an incident optical system is described using a sectional view of the optical scanning device 2 as seen in an A direction illustrated in FIG. 2. As described in FIG. 10, when an area having a pressure higher than a pressure at the periphery is generated on the incident laser beams ILc and ILK, an airflow flows from a high-pressure area to a low-pressure area, and thus an external airflow to the outside of the optical scanning device 2 is generated. The external airflow passes through the sub-scanning aperture diaphragms 103c and 103k arranged in the holding unit. Herein, the external airflow passes through the sub-scanning aperture diaphragms 103c and 103k as outflow paths. As described above, since an aperture size is small, an outflow amount can be reduced. The reduction in the outflow amount reduces an inflow amount from other aperture portions of the optical scanning device 2.

The other aperture portions may differ depending on a configuration of an optical scanning device. Examples of the other aperture portions include a passage hole through which a laser beam passes from an optical scanning device toward a photosensitive drum, and a mold cut-off hole arranged in a casing. The mold cut-off hole is a hole to secure a travel trajectory of a mold so that a desired shape is formed by the mold. The mold cut-off hole is necessary in a case where a pawl shape is formed to fix a lens or a spring in a casing. Since dust such as toner and paper powder is present outside the optical scanning device 2, reduction in an inflow amount from the outside reduces entry of the dust into the optical scanning device 2 and enhances dust-proof performance of the optical scanning device 2.

The acquisition of the dust-proof effect described in FIGS. 10 and 11 is not limited to the configuration of the optical scanning device 2. A similar effect can be acquired by a configuration in which a holding unit is arranged on an incident laser beam, and such a situation is to be described. First, if a general optical scanning device in which a first imaging lens is in the vicinity of a rotary polygon mirror and arranged along a Y direction is used, an internal airflow to be generated from the rotary polygon mirror in the ±Y directions is a similar airflow. Next, as for a wall shape causing generation of a higher air-pressure area when an airflow comes into contact with a wall, a wall arranged in a main-scanning aperture diaphragm in the present exemplary embodiment has such a function. However, even if there is not such a wall, a side wall is necessary in a configuration in which a holding unit is arranged on an incident beam. Consequently, an area having a higher pressure is generated when an internal airflow comes into contact with the side wall.

As long as the general optical scanning device in which a holding unit is arranged on an incident laser beam is used, an airflow similar to that in the present exemplary embodiment can be generated. Thus, reduction in aperture size of the holding unit can obtain a dust-proof effect.

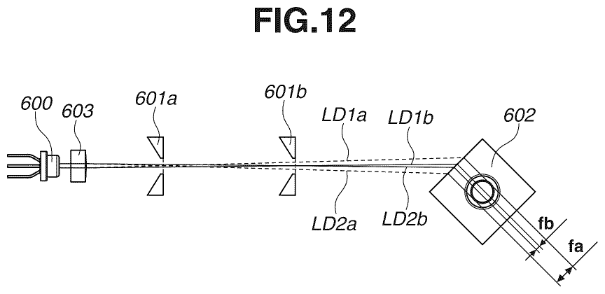

In the present exemplary embodiment, since a multi-beam element that emits a plurality of laser beams from one light source is assumed to serve as a light source, a main-scanning aperture diaphragm and a sub-scanning aperture diaphragm are disposed at separate positions. As for the multi-beam element, optical performance can be obtained if the main-scanning aperture diaphragm is positioned near the rotary polygon mirror 105. The details are described with reference to FIG. 12. FIG. 12 is a schematic diagram illustrating influence of a main-scanning aperture diaphragm position on performance when a multi-beam element is used. In FIG. 12, arrangement of each component is simplified for the sake of convenience of description. A multi-beam element 600 emits two laser beams from one element. The two laser beams pass through a collimator lens 603, and imaging states of the two laser beams at a rotary polygon mirror 602 differ depending on whether an optical path of the laser beam is determined by a main-scanning aperture diaphragm 601a positioned far from the rotary polygon mirror 602 or a main-scanning aperture diaphragm 601b positioned close to the rotary polygon mirror 602. Such a difference is described. In practice, a beam width of a laser beam is determined based on a width of a main-scanning aperture diaphragm. However, since the description is given of only the optical path, the laser beam is represented by a central axis of the laser beam in FIG. 12.

Two laser beams LD1a and LD2a, the optical paths of which are determined by the main-scanning aperture diaphragm 601a, have reflection points that are a distance fa apart at the rotary polygon mirror 602. On the other hand, two laser beams LD1b and LD2b, the optical paths of which are determined by the main-scanning aperture diaphragm 601b, have reflection points that are a distance fb apart at the rotary polygon mirror 602. Thus, a relation of fb<fa is provided. The shorter the reflection point distance between the laser beams on the rotary polygon mirror 602 is, the smaller the shift in the laser beam interval in a main-scanning direction becomes when a variation in imaging positions on a photosensitive drum occurs. Accordingly, in the present exemplary embodiment, a main-scanning aperture diaphragm is positioned closer to the rotary polygon mirror 105 than a sub-scanning aperture diaphragm.

In a case where a shift in a laser beam interval on a photosensitive drum can be accepted, or a single-beam element that emits one laser beam from one light source is used, the main-scanning aperture diaphragm can be arranged at a position of the sub-scanning aperture diaphragm. Such arrangement enhances flexibility in arrangement of an optical component.

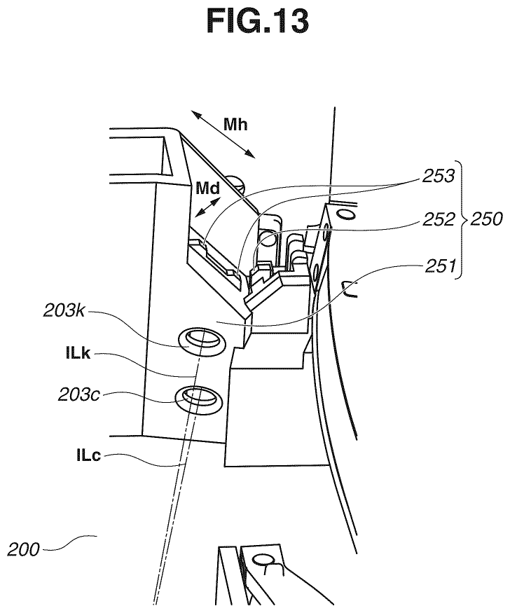

A modification example is described with reference to FIG. 13. FIG. 13 illustrates an optical scanning device in which a main-scanning aperture diaphragm is arranged at a position of a sub-scanning aperture diaphragm. Because the optical scanning device in FIG. 13 is similar to the optical scanning device 2 described above except for a housing, a description of each component is omitted. FIG. 13 is a perspective view of a position similar to the area P of the optical scanning device 2 illustrated in FIG. 2.

A holding unit 250 has a shape to hold a second reflection mirror 118c that is disposed similarly to the second reflection mirror 118c of the optical scanning device 2. FIG. 13 is a diagram in which the second reflection mirror and a pressing spring are excluded. The holding unit 250 includes a side wall 251 extending from a bottom of a housing 200, a contact surface 252 that contacts the second reflection mirror 118c in an Mh direction, and a contact surface 253 that contacts the second reflection mirror 118c in an Md direction. On the side wall 251, oval aperture diaphragms 203c and 203k are arranged. The oval aperture diaphragms 203c and 203k restrict beam widths in a main-scanning direction and a sub-scanning direction on a rotary polygon mirror 105.

In the modification example, the diaphragm has an oval shape. However, the diaphragm can have, for example, a rectangular shape as long as beam widths in both of the main-scanning and sub-scanning directions can be restricted.

In the modification example, the two-beam laser element that emits two laser beams from one element is used as a multi-beam element. However, a laser element that emits three or more laser beams from one element can be used.

The present exemplary embodiment has been described using a color image forming apparatus but is not limited to the color image forming apparatus. A similar effect can be obtained even by a monochrome image forming apparatus having a configuration in which a holding unit is arranged on an incident laser beam and an aperture through which the incident beam passes is necessary in the holding unit.

The present exemplary embodiment has been described using a reflection mirror as a component to be held by a holding unit, but the component is not limited to the reflection mirror. A similar effect can be obtained even in a case where an imaging lens holding unit is arranged on an incident laser beam.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-123751, filed Jul. 30, 2024, which is hereby incorporated by reference herein in its entirety.

What is claimed is:

1. An optical scanning device comprising:
a light source;
a rotary polygon mirror configured to deflect a light beam emitted from the light source;
a scanning lens through which the light beam deflected by the rotary polygon mirror passes;
a reflection mirror configured to reflect the light beam deflected by the rotary polygon mirror to guide the light beam to a surface to be scanned, the reflection mirror having an elongated shape in a longitudinal direction that is orthogonal to an axial direction of a rotational axis of the rotary polygon mirror; and
a casing configured to support the light source, the rotary polygon mirror, the scanning lens, and the reflection mirror,
wherein the casing includes a pair of holding units configured to hold both ends of at least one of the scanning lens or the reflection mirror in the longitudinal direction,
wherein, among the pair of holding units, the holding unit closer to the light source in the longitudinal direction has a side wall extending in the axial direction from a bottom of the casing, and
wherein, on the side wall, a diaphragm configured to restrict an incident beam to the rotary polygon mirror from the light source is arranged.

2. The optical scanning device according to claim 1, wherein the diaphragm is a sub-scanning diaphragm configured to restrict a width of a light beam in a sub-scanning direction.

3. The optical scanning device according to claim 2, wherein, between the sub-scanning diaphragm and the rotary polygon mirror, a main-scanning diaphragm configured to restrict a width of a light beam that forms an image on a surface to be scanned in a main-scanning direction is arranged.

4. The optical scanning device according to claim 2, further comprising:
the light source including a first light source and a second light source; and
the sub-scanning diaphragm including a first sub-scanning diaphragm and a second sub-scanning diaphragm, the first sub-scanning diaphragm being configured to restrict an incident beam to the rotary polygon mirror from the first light source and the second sub-scanning diaphragm being configured to restrict an incident beam to the rotary polygon mirror from the second light source,
wherein the second sub-scanning diaphragm is arranged at a position different from a position at which the first sub-scanning diaphragm is arranged in the axial direction.

5. The optical scanning device according to claim 4,
wherein, between the sub-scanning diaphragm and the rotary polygon mirror, a main-scanning diaphragm configured to restrict a width of a light beam that forms an image on a surface to be scanned in a main-scanning direction is arranged,
wherein the main scanning diaphragm includes a first main-scanning diaphragm and a second main-scanning diaphragm, the first main-scanning diaphragm being configured to restrict a light beam that has passed through the first sub-scanning diaphragm and the second main-scanning diaphragm being configured to restrict a light beam that has passed through the second sub-scanning diaphragm, and
wherein the first main-scanning diaphragm and the second main-scanning diaphragm are arranged on a rim of one hole extending in the axial direction.

6. An optical scanning device comprising:
a first light source;
a second light source;
a rotary polygon mirror configured to deflect a first light beam emitted from the first light source and a second light beam emitted from the second light source;
a scanning lens through which the first light beam deflected by the rotary polygon mirror passes;
a reflection mirror configured to reflect the first light beam deflected by the rotary polygon mirror to guide the first light beam to a surface to be scanned, the reflection mirror having an elongated shape in a longitudinal direction that is orthogonal to an axial direction of a rotational axis of the rotary polygon mirror; and
a casing configured to support the first light source, the second light source, the rotary polygon mirror, the scanning lens, and the reflection mirror,
wherein the casing includes a pair of holding units configured to hold both ends of at least one of the scanning lens or the reflection mirror in the longitudinal direction,
wherein, among the pair of holding units, the holding unit closer to the first light source in the longitudinal direction has a side wall extending in the axial direction from a bottom of the casing,
wherein, on the side wall, a first sub-scanning diaphragm and a second sub- scanning diaphragm are arranged, the first sub-scanning diaphragm being configured to restrict a width of the first light beam entering the rotary polygon mirror in a sub-scanning direction and the second sub-scanning diaphragm being configured to restrict a width of the second light beam entering the rotary polygon mirror in a sub-scanning direction, and
wherein the second sub-scanning diaphragm is arranged at a position different from a position in which the first sub-scanning diaphragm is arranged in the axial direction.

7. The optical scanning device according to claim 6, wherein a first main-scanning diaphragm configured to restrict a width of a first light beam in a main-scanning direction is arranged between the first sub-scanning diaphragm and the rotary polygon mirror, and a second main-scanning diaphragm configured to restrict a width of a second light beam in a main-scanning direction is arranged between the second sub-scanning diaphragm and the rotary polygon mirror.

8. The optical scanning device according to claim 7, wherein the first main-scanning diaphragm and the second main-scanning diaphragm are arranged on a rim of one hole extending in the axial direction.
